(19) United States
(12) Patent Application Publication
(10) Pub. No.: US 2017/0097934 A1
(43) Pub. Date: Apr. 6, 2017

(54) METHOD OF PROVIDING COOKING RECIPES

(71) Applicant: Panasonic Intellectual Property Corporation of America, Torrance, CA (US)

(72) Inventors: MITSUHIRO ASO, Osaka (JP); ATSUKO OONO, Tokyo (JP); YOSHIMI NISHII, Kyoto (JP); HIROKAZU KITO, Osaka (JP); HIROKO SUGIMOTO, Kyoto (JP)

(21) Appl. No.: 15/256,735

(22) Filed: Sep. 6, 2016

(30) Foreign Application Priority Data
Oct. 2, 2015 (JP) 2015-196854
Jul. 19, 2016 (JP) 2016-141907

(51) Int. Cl. G06F 17/30; A23L 5/00

(52) U.S. Cl. CPC G06F 17/3053; A23L 5/00; A23V 2002/00

(57) ABSTRACT

A cooking recipe providing method of providing cooking recipes uses a database storing pieces of cooking recipe information including use ingredient information indicating ingredients to be used for cooking, and includes: receiving from an information terminal, ingredient information indicating a type and amount of an ingredient, and cooking recipe specification information specifying first cooking recipe information whose use ingredient information does not include the ingredient in the ingredient information; extracting a second cooking recipe information similar to the first cooking recipe information in the received cooking recipe specification information from the pieces of cooking recipe information stored in the database; and when the ingredient in the ingredient information is included in the use ingredient information of the second cooking recipe information, generating a third cooking recipe information by adding the ingredient in the ingredient information to the use ingredient information of the first cooking recipe information as an additional ingredient.

### BACKGROUND

1. Technical Field

The present disclosure relates to a method of providing cooking recipes in a cooking recipe providing system that is connected to an information terminal via a network and that provides cooking recipes.

2. Description of the Related Art

In related art, a recipe customization supporting system has been disclosed that provides a user with recipes which partially reflect a change desired by the user (see, for instance, Japanese Unexamined Patent Application Publication No. 2006-139694).

### SUMMARY

However, further improvement needs to be made in Japanese Unexamined Patent Application Publication No. 2006-139694.

In one general aspect, the techniques disclosed here feature a method of providing cooking recipes in a cooking recipe providing system that is connected to an information terminal via a network and that provides cooking recipes. The cooking recipe providing system includes a database that stores a plurality of pieces of cooking recipe information, each of which has use ingredient information which indicates ingredients to be used for cooking, and the cooking recipe providing method includes: receiving from the information terminal, ingredient information indicating a type and an amount of an ingredient, and cooking recipe specification information specifying a first cooking recipe information in which the use ingredient information does not include the ingredient indicated by the ingredient information; extracting a second cooking recipe information similar to the first cooking recipe information indicated by the received cooking recipe specification information from the pieces of cooking recipe information stored in the database; and when the ingredient indicated by the ingredient information is included in the use ingredient information of the extracted second cooking recipe information, generating a third cooking recipe information in which the ingredient indicated by the ingredient information is added to the use ingredient information of the first cooking recipe information as an additional ingredient.

According to the above-described aspect, further improvement may be achieved.

It should be noted that general or specific embodiments may be implemented as a system, a method, an integrated circuit, a computer program, a storage medium such as a computer-readable CD-ROM, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic illustration depicting the configuration of a cooking recipe providing system in an embodiment;

FIG. 2 is a block diagram illustrating the configuration of the cooking recipe providing system in the embodiment;

FIG. 3 is a chart illustrating an example of a plurality of pieces of cooking recipe information stored in a database;

FIG. 4 is a table illustrating an example of standard input information stored in the database;

FIG. 5 is a table illustrating an example of ingredient type information stored in the database;

FIG. 6 is a flow chart illustrating an example of processing of a cooking recipe providing method performed by a server system of the cooking recipe providing system in the embodiment;

FIG. 7 is a flow chart illustrating an example of extraction processing of the cooking recipe providing method;

FIG. 8 is a flow chart illustrating an example of generation processing of the cooking recipe providing method;

FIG. 9 is a flow chart illustrating processing of a cooking recipe acquisition method performed in an information terminal of the cooking recipe providing system in the embodiment;

FIG. 10 is a chart illustrating an example of UI (User Interface) for input in an application of an information terminal;

FIG. 11 is a chart illustrating another example of the pieces of cooking recipe information stored in the database;

FIG. 12 is a chart illustrating an example of third cooking recipe information generated by a generator of the server system;

FIG. 13 is an example of display of recipe C indicated by the third cooking recipe information;

FIG. 14 is an example of display of recipe A and recipe C in a comparison format;

FIG. 15 is a chart illustrating cooking recipe information indicating recipe A1;

FIG. 16 is a chart illustrating cooking recipe information indicating recipe A2;

FIG. 17 is a chart illustrating cooking recipe information similar to the cooking recipe information of recipe A1;

FIG. 18 is a chart illustrating cooking recipe information similar to the cooking recipe information of recipe A2;

FIG. 19 is a chart illustrating an example of third cooking recipe information generated by the generator of the server system;

FIG. 20 is a chart illustrating an example of third cooking recipe information generated by a generator of the server system;

FIG. 21 is a display example of recipe C1 indicated by cooking recipe information; and

FIG. 22 is a display example of recipe C2 indicated by cooking recipe information.

### DETAILED DESCRIPTION

### Underlying Knowledge Forming Basis of the Present Disclosure

The inventor has found that the following problem occurs in the recipe customization supporting system described in “Description of the Related Art”.

In general, in a case where a user purchases ingredients and cooks the ingredients according to a desired cooking recipe, the amounts of ingredients purchasable by the user do not often match the amounts of ingredients to be used in the cooking recipe. For this reason, when a user tries to cook according to the content of the cooking recipe, the user usually purchases ingredients in amounts more than the amounts in the ingredients presented in the cooking recipe. Thus, some of the ingredients are left unused.

Although customization of recipes is described in Japanese Unexamined Patent Application Publication No. 2006-139694, unused ingredients are not taken into consideration. Consequently, in order to consume the unused ingredients, a user has to do some extra work. For instance, to consume the unused ingredients, a user has to search for a cooking recipe on the Internet using an information terminal. Even when a cooking recipe is retrieved, the amounts of ingredients currently left may not match the amounts of ingredients presented in the cooking recipe. For this reason, it takes time for the user to search for an appropriate cooking recipe. Like this, since a user operates an information terminal for an extra time to search for an appropriate cooking recipe, electric power has to be consumed needlessly.

Based on the above analysis, the inventor has devised the following remedy in order to solve the above-mentioned problem.

A cooking recipe providing method according to an aspect of the present disclosure is a method of providing cooking recipes in a cooking recipe providing system that is connected to an information terminal via a network and that provides cooking recipes. The cooking recipe providing system includes a database that stores a plurality of pieces of cooking recipe information, each of which has use ingredient information indicating ingredients to be used for cooking. The cooking recipe providing method includes: receiving from the information terminal, ingredient information indicating a type and an amount of an ingredient, and cooking recipe specification information specifying a first cooking recipe information in which the use ingredient information does not include the ingredient indicated by the ingredient information; extracting a second cooking recipe information similar to the first cooking recipe information indicated by the received cooking recipe specification information from the pieces of cooking recipe information stored in the database; and when the ingredient indicated by the ingredient information is included in the use ingredient information of the extracted second cooking recipe information, generating a third cooking recipe information in which the ingredient indicated by the ingredient information is added to the use ingredient information of the first cooking recipe information as an additional ingredient.

Thus, only by specifying an ingredient and a cooking recipe, a user is able to obtain a cooking recipe which includes the specified ingredient and in which the specified ingredient is added to the specified cooking recipe based on a cooking recipe similar to the specified cooking recipe. Thus, for instance, when a user specifies unused ingredient and a desired dish, a cooking recipe may be easily obtained, in which the unused ingredient is added to an ingredient menu indicated by a cooking recipe for the specified dish. Therefore, it is possible to use up the ingredient and to reduce consumption of unnecessary power.

Also, one of the plurality of recipes may further include at least one of a type of ingredient to be used for cooking of dishes indicated by the recipe, a type of seasoning used for the cooking, and a cooking type of the cooking, and in the extracting, a degree of similarity between the first recipe and each of the recipes may be determined using at least one of the type of ingredient, the type of seasoning, and the cooking type included in the first recipe, and the second recipe may be extracted from the recipes based on the degree of similarity obtained in the determining.

According to this, the second recipe is extracted from the plurality of recipes based on a degree of similarity determined using at least one of the type of ingredient, the type of seasoning and the type of cooking, thereby making it possible to appropriately extract the second recipe similar to the first recipe.

Also, one of the plurality of recipes may further include a taste information value that represents at least one of sweetness, sourness, saltiness, bitterness, umami and pungent taste in terms of numerals, and in the extracting, a degree of similarity between the first recipe and each of the recipes may be determined using the taste information value, and the second recipe may be extracted from the recipes based on the degree of similarity obtained in the determining.

According to this, the second recipe is extracted from the plurality of recipes based on a degree of similarity determined using the taste information value, thereby making it possible to appropriately extract the second recipe similar to the first recipe.

Also, the use ingredient information may include information that indicates an amount of ingredient to be used for cooking, and in the generating, an amount of the additional ingredient in the use ingredient information of the third recipe may be determined to be the amount of the ingredient indicated by the use ingredient information of the second recipe, and a recipe including information indicating the amount of the additional ingredient obtained in the determining may be generated as the third recipe.

According to this, an amount of the additional ingredient in the use ingredient information of the third recipe is determined to be the amount of ingredient indicated by the use ingredient information of the second recipe, thereby making it possible to appropriately determine the amount of the additional ingredient.

Also, the use ingredient information may include information that indicates an amount of ingredient to be used for cooking, each of the plurality of recipes may include additional amount information that, for each of ingredients indicated by the use ingredient information included in the recipe, indicates an amount of the ingredient allowed to be added, and in the generating, an amount of the additional ingredient in the use ingredient information of the third recipe may be determined in a range of the amount indicated by the additional amount information, and a recipe including information indicating the amount of the additional ingredient obtained in the determining may be generated as the third recipe.

According to this, an amount of the additional ingredient in the use ingredient information of the third recipe is determined in a range of the amount indicated by the additional amount information, thereby making it possible to appropriately determine the amount of the additional ingredient.

Also, in the generating, at least one of the ingredient indicated by the use ingredient information of the first recipe is selected, and a recipe obtained by adding the additional ingredient instead of the selected ingredient may be generated as the third recipe.

According to this, the additional ingredient is added as an alternative ingredient, and thus the additional ingredient may be used for cooking without increasing the amount of finished dish.

Also, one of the plurality of recipes may include cooking procedure information that indicates a cooking procedure, and in the generating, a recipe may be generated as the third recipe, the recipe being obtained by adding a cooking procedure for the additional ingredient to a cooking procedure indicated by the cooking procedure information of the first recipe.

According to this, a cooking procedure for the additional ingredient added as the third recipe enables a user to cook, for instance, an unused ingredient appropriately.

Also, in the generating, a cooking procedure for preparation of the additional ingredient included in cooking procedure information of the second recipe is added to the cooking procedure information of the first recipe, and a recipe obtained by the addition may be generated as the third recipe.

According to this, a recipe is generated as the third recipe in which a cooking procedure for preparation of the additional ingredient included in cooking procedure information of the second recipe is added, and thus a user is enabled to cook, for instance, an unused ingredient appropriately.

Also, one of the plurality of recipes may include cooking type information that indicates a cooking type of dishes indicated by the recipe, as the cooking procedure, the cooking procedure information may indicate a cooking procedure for preparation of ingredient corresponding to a type of an ingredient and a cooking type of dish, and the generating may include determining whether or not cooking type information of the first recipe matches cooking type information of the extracted second recipe, and when determining that the cooking type information of the first recipe is different from the cooking type information of the second recipe in the determination, referring to the database to generate as the third recipe, a recipe in which a cooking procedure for preparation of the additional ingredient corresponding to the cooking type information of the first recipe is added to the cooking procedure information of the first recipe.

According to this, even when the cooking type information of the first recipe is different from the cooking type information of the second recipe, a recipe is generated as the third recipe, in which a cooking procedure appropriate to the additional ingredient and the cooking type of an addition destination cooking recipe is added, and thus a user is able to cook, for instance, an unused ingredient appropriately.

Also, the use ingredient information may include ingredient type information that indicates an ingredient type of an ingredient, and in the generating, an additional cooking procedure, which is a cooking procedure for input of the additional ingredient to a cooking utensil, may be generated, and cooking recipe information may be generated as the third recipe, the cooking recipe information being obtained by adding the generated additional cooking procedure to the cooking procedure information of the first recipe either before or after a cooking procedure for input of an ingredient of the same ingredient type as the additional ingredient to the cooking utensil, out of the ingredients indicated by the use ingredient information of the first recipe.

According to this, as the third recipe, a sequence number for an additional cooking procedure as a cooking procedure for input of the additional ingredient to a cooking utensil is determined to the sequence number either before or after a cooking procedure for input of an ingredient of the same ingredient type as the additional ingredient to the cooking utensil, thereby making it possible to appropriately determine a sequence number for cooking of the additional ingredient.

Also, one of the plurality of recipes may include cooking type information that indicates a cooking type of dishes indicated by the recipe, the use ingredient information may further include ingredient type information that indicates an ingredient type of an ingredient, the database may further store standard input information that indicates an input sequence number of the ingredient to a cooking utensil corresponding to the ingredient type and the cooking type, and the generating may include generating an additional cooking procedure, which is a cooking procedure for input of the additional ingredient to a cooking utensil, and generating, as the third recipe, a recipe in which the generated additional cooking procedure is added to the cooking procedure information of the first recipe based on the standard input information.

According to this, a recipe is generated as the third recipe by adding the generated additional cooking procedure to the cooking procedure information of the first recipe based on the standard input information, thereby making it possible to determine an appropriate sequence number for cooking of the additional ingredient.

Also, in the extracting, when the received cooking recipe specification information specifies plural first recipes, a second recipe similar to each of the first recipes may be extracted from the recipes stored in the database, and in the generating, when the ingredient indicated by the ingredient information is included in the use ingredient information of any of the extracted plural second recipes corresponding to the plural first recipes, the third recipe may be generated, in which the ingredient indicated by the ingredient information is added to the use ingredient information of the first recipe as an additional ingredient.

According to this, even when the received cooking recipe specification information specifies plural first recipes, a second recipe similar to each of the plural first recipes is extracted, and the third recipe is generated, in which the additional ingredient is added. Thus, for instance, when a user specifies an unused ingredient and any dish, a cooking recipe may be easily obtained, in which the unused ingredient is more effectively added to an ingredient menu indicated by a cooking recipe for the specified dish.

Also, display information for displaying the use ingredient information of the first recipe and the use ingredient information of the third recipe in a comparison format may further be transmitted to the information terminal.

Thus, the information terminal is able to display the use ingredient information of the first recipe and the use ingredient information of the third recipe in a comparison format, which allows a user to efficiently determine whether or not the displayed third recipe is to be adopted.

Hereinafter, a cooking recipe providing method in a cooking recipe providing system according to an aspect of the present disclosure will be specifically described with reference to the drawings.

It is to be noted that each of the embodiments described below illustrates a specific example of the present disclosure. The numerical values, shapes, materials, components, arrangement positions and connection configuration of the components, steps, and order of the steps that are presented in the following embodiments are examples, which are not intended to limit the present disclosure. In the following embodiments, the components thereof, which are not described in the independent claim that defines the most generic concept of the present disclosure, are regarded as any components.

### Embodiment

An embodiment will be described.

### <Configuration of Cooking Recipe Providing System>

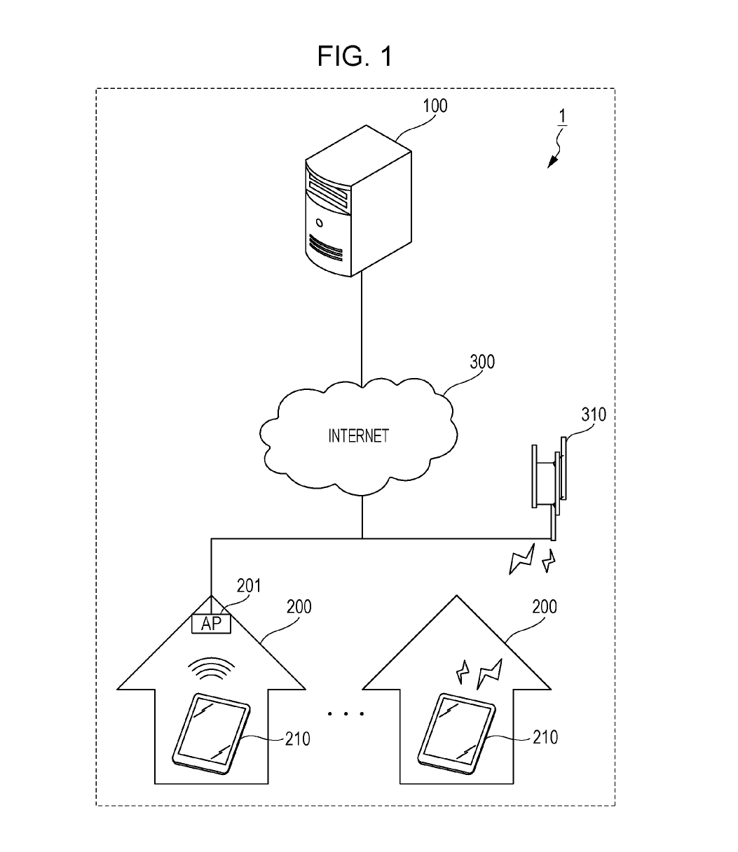

First, the outline of the configuration of a cooking recipe providing system in an embodiment of the present disclosure will be described with reference to FIG. 1.

FIG. 1 is a schematic illustration depicting the configuration of a cooking recipe providing system 1 in the embodiment.

As illustrated in FIG. 1, the cooking recipe providing system 1 according to the embodiment includes a server system 100 and an information terminal 210 connected to the server system 100 via the Internet 300.

The information terminal 210 is mainly provided inside a house 200. Also, the information terminal 210 may be connected to the Internet 300 by being wirelessly connected to a wireless LAN access point (AP) 201 for establishing wireless connection such as Wi-Fi (registered trademark) in the house 200, or by communicating with a base station 310 included in a mobile phone communication network. The above-described form of connection of the information terminal 210 to the Internet 300 is an example, and form of connection to the Internet 300 is not limited to the connection form described above. In other words, although the information terminal 210 is connected to the Internet 300 via wireless connection in the example of FIG. 1, the information terminal 210 may be connected to the Internet 300 via a wired connection not wireless connection.

Next, a specific configuration of the server system 100 and the information terminal 210 included in the cooking recipe providing system 1 will be described.

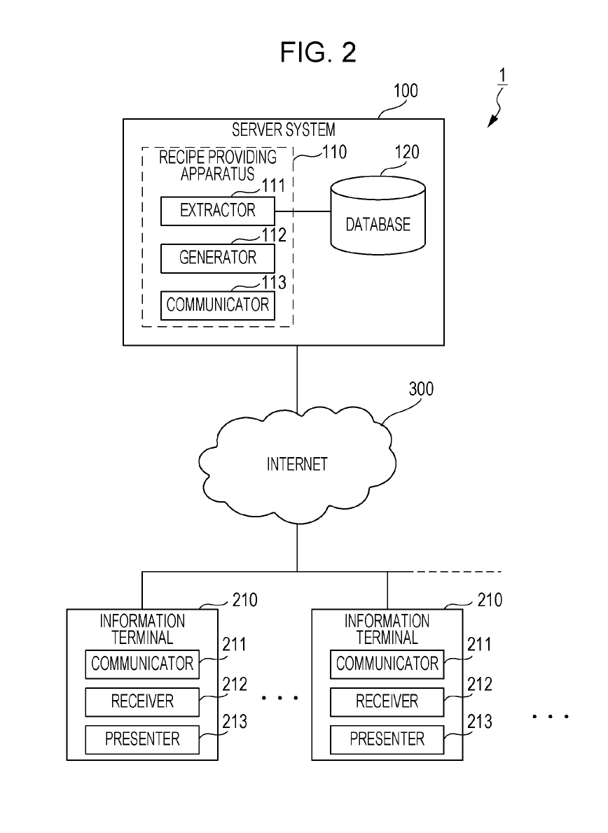

FIG. 2 is a block diagram illustrating the configuration of the cooking recipe providing system 1 in the embodiment.

### <Server System>

As illustrated in FIG. 2, the server system 100 includes a recipe providing apparatus 110 and a database 120.

The recipe providing apparatus 110 selects at least one of a plurality of pieces of cooking recipe information stored in the database 120, and transmits and provides cooking recipe, which is generated based on the selected at least one cooking recipe information, to the information terminal 210. The recipe providing apparatus 110 is implemented, for instance, by a microcomputer, a processor, or a dedicated circuit.

The database 120 stores a plurality of pieces of cooking recipe information including use ingredient information that is for a plurality of types of cooking and that indicates a plurality of ingredients to be used for the cooking. The database 120 is implemented, for instance, by a memory device such as a hard disk drive, a nonvolatile memory.

The recipe providing apparatus 110 has an extractor 111, a generator 112, and a communicator 113.

The communicator 113 receives from the information terminal 210 ingredient information indicating a type and an amount of an ingredient, and cooking recipe specification information specifying first cooking recipe information in which use ingredient information does not include the ingredient indicated by the ingredient information. The ingredient information and the cooking recipe specification information are, for instance, information provided by a user inputting to the information terminal 210. The communicator 113 receives an identifier for identifying the information terminal 210 along with the ingredient information and the cooking recipe specification information.

In addition, the communicator 113 transmits to the information terminal 210 display information for displaying the use ingredient information of the first cooking recipe information and the use ingredient information of third cooking recipe information in a comparison format.

The extractor 111 extracts second cooking recipe information similar to the first cooking recipe information indicated by the cooking recipe specification information received by the communicator 113, from a plurality of pieces of cooking recipe information stored in the database 120.

Specifically, in the extraction, the extractor 111 determines a degree of similarity between the first cooking recipe information and each of the pieces of cooking recipe information stored in the database 120 by using at least one of an ingredient type, a seasoning type, and a cooking type included in the first cooking recipe information. The extractor 111 then extracts second cooking recipe information from the pieces of cooking recipe information based on the degree of similarity obtained in the determining. Specific examples of determination of the degree of similarity will be described later.

The generator 112 determines whether or not the ingredient indicated by the ingredient information received by the communicator 113 is included in the use ingredient information included in the second cooking recipe information extracted by the extractor 111. When it is determined that the ingredient indicated by the ingredient information is included in the use ingredient information included in the second cooking recipe information, the generator 112 generates third cooking recipe information. The third cooking recipe information is cooking recipe information in which the ingredient indicated by the ingredient information is added to the use ingredient information of the first cooking recipe information as additional ingredient. In other words, when the ingredient inputted by a user is included in the second cooking recipe information similar to the first cooking recipe information, the generator 112 generates third cooking recipe information by adding the ingredient to the first cooking recipe information as additional ingredient.

Specifically, in the generating, the generator 112 determines that an amount of an additional ingredient in the use ingredient information of the third cooking recipe information is the amount of the ingredient indicated by the use ingredient information of the second cooking recipe information. The generator 112 generates third cooking recipe information which is cooking recipe information including information indicating the amount of the additional ingredient obtained in the determining.

Further in the generating, the generator 112 generates the third cooking recipe information which is cooking recipe information by adding the cooking procedure for the additional ingredient to the cooking procedure indicated by cooking procedure information of the first cooking recipe information. Specifically, in the generating, the generator 112 adds cooking procedure for preparation of the additional ingredient included in the cooking procedure information of the second cooking recipe information to the cooking procedure information of the first cooking recipe information, and generates the third cooking recipe information which is cooking recipe information obtained by the addition.

### <Information Terminal>

The information terminal 210 includes a communicator 211, a receiver 212, and a presenter 213. The information terminal 210 is a portable computer such as a smartphone, a tablet, a laptop PC. It is to be noted that the information terminal 210 is not limited to a portable computer, and may be a computer installed in the kitchen of a house 200, for instance.

The communicator 211 is connected to the Internet 300 via wireless connection such as Wi-Fi or a mobile phone communication network, and communicates with the server system 100. Specifically, the communicator 211 transmits to the server system 100 ingredient information, cooking recipe specification information, identification information of the information terminal 210 received by the receiver 212. Here, the identification information may be, specifically, the MAC address of the information terminal 210, a mail address registered by a user, an ID set by a user for logging in the server system 100, or an ID associated with an application installed in the information terminal 210 for a user to be provided with cooking recipe from the server system 100. In short, the identification information may be any information as long as the information makes it possible to identify the destination to the information terminal 210 as a transmission target when the server system 100 transmits information to the information terminal 210.

Also, the communicator 211 receives the third cooking recipe information from the server system 100. The communicator 211 is implemented, for instance, by a Wi-Fi module, a mobile phone communication module.

The receiver 212 is an input device that receives input from a user. Specifically, the receiver 212 receives input for specifying ingredient information, and input for determining cooking recipe specification information. The receiver 212 is implemented, for instance, by an input device such as a touch panel, a keyboard, and a button.

The presenter 213 is a displayer. Specifically, the presenter 213 displays an image and a character string that indicate the third cooking recipe information received by the communicator 211 from the server system 100. The presenter 213 is implemented by, for instance, a display device such as a liquid crystal display, an organic EL display. It is to be noted that the presenter 213 is not limited to a device that visually presents information to a user with an image, and may be a device (for instance, a speaker) that aurally presents information to a user with voice.

Next, the information stored in the database 120 will be described.

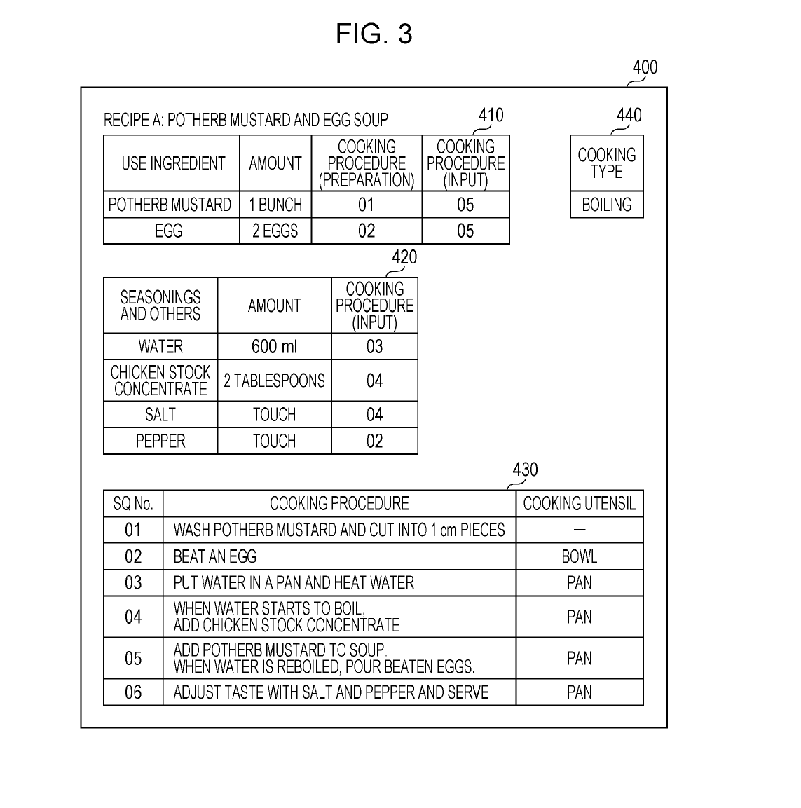

FIG. 3 is a chart illustrating an example of information of a plurality of pieces of cooking recipe information stored in the database 120. FIG. 3 illustrates first cooking recipe information 400 out of the pieces of cooking recipe information.

As illustrated in FIG. 3, the first cooking recipe information 400 includes use ingredient information 410, seasoning information 420, cooking procedure information 430, and cooking type information 440. Here, although the first cooking recipe information 400 is described, other cooking recipe information has the same configuration as the first cooking recipe information 400.

The use ingredient information 410 provides the information regarding the ingredient to be used for cooking corresponding to the first cooking recipe information. Specifically, the use ingredient information 410 provides the information in which (type of) each ingredient to be used for the cooking, an amount of the ingredient to be used for the cooking, a cooking procedure for preparation of the ingredient, and a cooking procedure for input of the ingredient in a cooking utensil are associated with each other.

In FIG. 3, the (type of) ingredient is stored in “ingredient to be used” field, the amount of the ingredient is stored in “amount” field, the cooking procedure for preparation is stored in “cooking procedure (preparation)” field, and the cooking procedure for input of the ingredient is stored in “cooking procedure (input)” field. In FIG. 3, each ingredient, and a cooking procedure for preparation and a cooking procedure for input are each associated with a number stored in “SQ No.” field of the cooking procedure information 430. Specifically, since the cooking procedure for preparation of “potherb mustard” is identifiable by “01” in the use ingredient information, the cooking procedure corresponding to “01” of the cooking procedure information 430 is given by “potherb mustard is washed and cut into 1 cm pieces”.

The seasoning information 420 provides the information on the seasoning to be used for cooking corresponding to the first cooking recipe information. Specifically, the seasoning information 420 is the information in which (type of) each SEASONINGS AND OTHERS to be used for the cooking, an amount of SEASONINGS AND OTHERS to be used for the cooking, a cooking procedure for input of the SEASONINGS AND OTHERS in a cooking utensil are associated with each other.

In FIG. 3, the (type) of the SEASONINGS AND OTHERS is stored in “seasoning” field, the amount of SEASONINGS AND OTHERS is stored in “amount” field, and the cooking procedure for input of the seasoning is stored in “cooking procedure (input)” field. In FIG. 3, similarly to the relationship between each ingredient and its cooking procedure in the use ingredient information 410, each SEASONINGS AND OTHERS and a cooking procedure for input of the seasoning are each associated with a number stored in the “SQ No.” field of the cooking procedure information 430.

The cooking procedure information 430 provides the information regarding the cooking procedure used for cooking corresponding to the first cooking recipe information. Specifically, the cooking procedure information 430 provides the information in which a sequence number of a cooking procedure, the cooking procedure of the sequence number, and a cooking utensil used in the cooking procedure are associated with each other.

In FIG. 3, a sequence number is stored in the “SQ No.” field, a cooking procedure is stored in “cooking procedure” field, and a cooking utensil is stored in “cooking utensil” field. It is to be noted that the cooking utensil here is a utensil to which an ingredient is inputted, for instance, a bowl, a pan, a frying pan.

The cooking type information 440 provides the information indicating the type of cooking corresponding to the first cooking recipe information. The “cooking type” referred herein specifically indicates a method of processing the ingredient and seasoning corresponding to the cooking, such as grilling, boiling, steaming, deep-frying, stir-frying, dressing, soaking. It is to be noted that although the cooking type information 440 of the first cooking recipe information 400 indicates only one cooking type “boiling”, without being limited to this, two or more cooking types may be indicated depending on cooking.

The same ingredient may be cooked in different ways depending on a recipe. For instance, the case where ⅔ of a carrot is cut in rectangles and the remaining ⅓ is cut into small pieces. In this case, the “ingredient to be used” field in the use ingredient information 410 of the cooking recipe information has two items of carrot, and “⅔”, “⅓” are listed respectively in corresponding “amount” fields. In the “cooking procedure (preparation)” field, different pieces of information are referred, that are listed in the “SQ No.” field of the cooking procedure information 430. In the above-described case, one item of carrot may be listed in the “ingredient to be used” field of the use ingredient information 410. However, in this case, multiple (two) pieces of information are listed in the “amount” field, the “cooking procedure (preparation)” field and/or the “cooking procedure (input)” field.

In the example illustrated in FIG. 3, the information listed in the “SQ No.” field of the cooking procedure information 430 is referred by each of the “cooking procedure (preparation)” field of the use ingredient information 410 and the “cooking procedure (input)” field of the seasoning information 420. However, for instance, the use ingredient information 410 and the seasoning information 420 may each have “number” field which is not illustrated, and the cooking procedure information 430 may have “reference ingredient” field which is not illustrated. In this case, a different number is listed in the “number” field for each ingredient to be used or seasoning, and information listed in the “number” field of the use ingredient information 410 and the seasoning information 420 is referred in “reference ingredient” field of the cooking procedure information 430. It is to be noted that the database 120 may be designed in any manner without being limited to the above-described configuration.

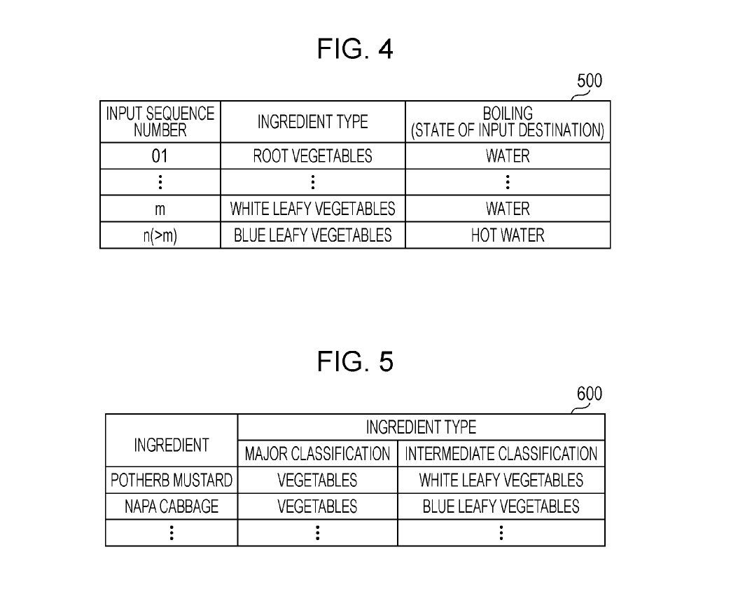

FIG. 4 is a table illustrating an example of standard input information 500 stored in the database 120. It is to be noted that the standard input information 500 does not have to be stored in the database 120.

The standard input information 500 provides the information indicating a sequence number of input of an ingredient in a cooking utensil corresponding to an ingredient type and a cooking type. As illustrated in FIG. 4, the standard input information 500 is information in which an input sequence number, an ingredient type, and a cooking type are associated with each other.

In FIG. 4, an input sequence number is stored in “input sequence number” field, and an ingredient type is stored in “ingredient type” field. The standard input information 500 indicates that an ingredient corresponding to an ingredient type with a larger number indicated in the “input sequence number” field is inputted to a cooking utensil as an input destination after an ingredient corresponding to an ingredient type with a smaller number in the field is inputted. Specifically, it is indicated that white leafy vegetables are inputted to a cooking utensil (for instance, a pan) after root vegetables are inputted, and blue leafy vegetables are inputted to the cooking utensil after the white leafy vegetables are inputted.

Also, the standard input information 500 illustrated in FIG. 4 provides the standard input information in the case where the cooking type is “boiling”, and “boiling (state of input destination)” field indicates a preferable state of the input destination when the cooking type is “boiling”. Specifically, it is indicated that root vegetables and white leafy vegetables are inputted when the state of the water in a cooking utensil is still “unboiled water”, and it is indicated that blue leafy vegetables are inputted after the state of the water in the cooking utensil has changed to boiled “hot water”, for instance.

FIG. 5 is a table illustrating an example of ingredient type information 600 stored in the database 120. It is to be noted that the ingredient type information 600 does not have to be stored in the database 120.

As illustrated in FIG. 5, the ingredient type information 600 provides information in which a (type of) ingredient and an ingredient type are associated with each other. In FIG. 5, the (type of) ingredient is stored in “ingredient” field, major classification of ingredient type is stored in “major classification” field of the “ingredient type” field, and intermediate classification of ingredient type is stored in “intermediate classification” field of the “ingredient type” field. In FIG. 5, it is indicated that for instance, “potherb mustard” has a major classification of “vegetable”, and an intermediate classification of “white leafy vegetable”.

### <Cooking Recipe Providing Method>

Next, the processing of a cooking recipe providing method performed by the cooking recipe providing system 1 will be described. First, the processing performed by the server system 100 will be described.

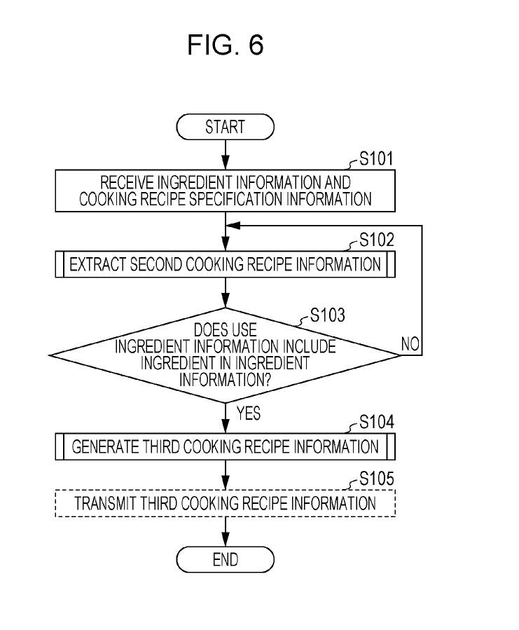

FIG. 6 is a flow chart illustrating an example of processing of a cooking recipe providing method performed by the server system 100 of the cooking recipe providing system 1 in the embodiment.

First, the communicator 113 of the server system 100 receives from the information terminal 210 ingredient information, cooking recipe specification information specifying first cooking recipe information in which use ingredient information does not include the ingredient indicated by the ingredient information, and identification information of the information terminal 210 (S101).

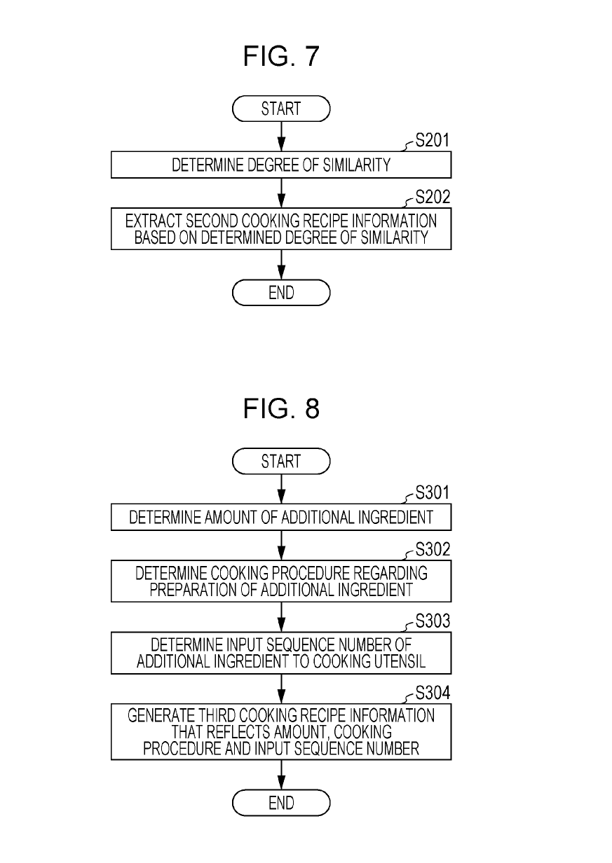

Next, the extractor 111 extracts second cooking recipe information similar to the first cooking recipe information indicated by the cooking recipe specification information received in step S101, from a plurality of pieces of cooking recipe information stored in the database 120 (S102). The specific processing in step S102 will be described later with reference to FIG. 7.

Next, the generator 112 determines whether or not the ingredient indicated by the ingredient information is included in the use ingredient information of the second cooking recipe information extracted in step S102 (S103). When it is determined that the ingredient indicated by the ingredient information is included in the use ingredient information of the second cooking recipe information (Yes in S103), the generator 112 generates third cooking recipe information by adding the ingredient indicated by the ingredient information to the use ingredient information of the first cooking recipe information as additional ingredient (S104). The specific processing in step S104 will be described later with reference to FIG. 8.

On the other hand, when it is determined that the ingredient indicated by the ingredient information is not included in the use ingredient information of the second cooking recipe information (No in S103), the flow returns to step S102.

After step S104, the communicator 113 transmits the third cooking recipe information generated in step S104 addressed to the information terminal 210 identified by the identification information received in step S101 (S105).

It is to be noted that the communicator 113 does not have to transmit the third cooking recipe information addressed to the information terminal 210. For instance, the communicator 113 may transmit information such as a URL for accessing the third cooking recipe information via e-mail, or may generate the third cooking recipe information and transmit to the information terminal 210 a message informing that the third cooking recipe information is uploaded to a predetermined website.

### (Extraction Processing)

Next, the processing (extraction processing) of extracting the second cooking recipe information in step S102 will be specifically described.

FIG. 7 is a flow chart illustrating an example of extraction processing of the cooking recipe providing method.

In step S102, the extractor 111 first determines a degree of similarity between the first cooking recipe information and each of the pieces of cooking recipe information stored in the database 120 (S201). Specifically, a point is accumulated according to matching of the type of ingredient, the type of seasoning, or the cooking type between the first cooking recipe information and each of the pieces of cooking recipe information, and a degree of similarity is determined in terms of the accumulated points. For instance, in the case of type of ingredient, comparison is made for the ingredient type information of each ingredient included in the use ingredient information 410, and 1 point is accumulated for matching of major classification, 2 points are accumulated for matching of intermediate classification, and 3 points are accumulated for matching of ingredient itself. The same goes with the case of type of seasoning. For cooking type, 3 points are accumulated for matching of the cooking type. Thus, by comparing each of other pieces of cooking recipe information with the first cooking recipe information, a degree of similarity is determined in terms of point.

Next, the extractor 111 extracts the second cooking recipe information from the pieces of cooking recipe information stored in the database 120 based on the degree of similarity determined in step S201 (S202). Specifically, the extractor 111 may extract a cooking recipe with the highest degree of similarity to the first cooking recipe information out of the pieces of cooking recipe information, as the second cooking recipe information. Alternatively, the extractor 111 may extract a cooking recipe randomly selected from cooking recipes having a degree of similarity with a predetermined threshold value or higher, as the second cooking recipe information.

### (Generation Processing)

Next, the processing (generation processing) of generating the third cooking recipe information in step S104 will be specifically described.

FIG. 8 is a flow chart illustrating an example of generation processing of the cooking recipe providing method.

In step S104, the generator 112 determines an amount of additional ingredient which is the ingredient indicated by the ingredient information received by the communicator 113 (S301).

Next, the generator 112 determines a cooking procedure for preparation of the additional ingredient (S302).

Next, the generator 112 determines an input sequence number of the additional ingredient in a cooking utensil (S303).

The generator 112 then generates the third cooking recipe information by reflecting the amount of the additional ingredient, the cooking procedure, the input sequence number determined in steps S301-S303 to the first cooking recipe information (S304).

### (Processing in Information Terminal)

Next, the processing performed by the information terminal 210 will be described.

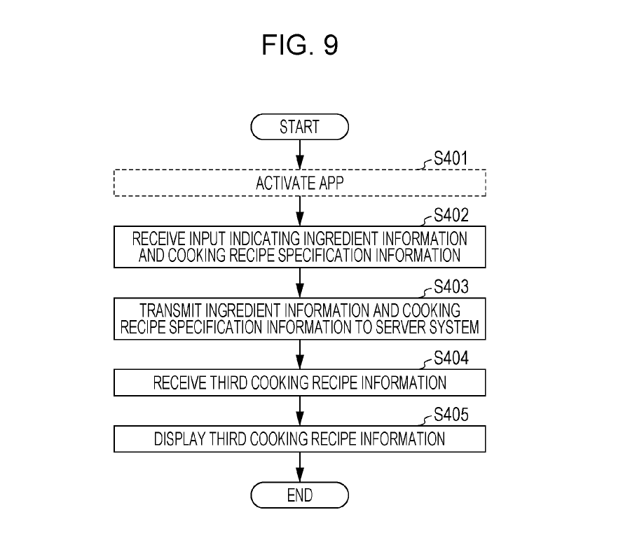

FIG. 9 is a flow chart illustrating the processing of a cooking recipe acquisition method performed in the information terminal 210 of the cooking recipe providing system 1 in the embodiment.

In the information terminal 210, the receiver 212 receives input, for instance, for activating an application installed in the information terminal 210 for a user to be provided with cooking recipe from the server system 100, and activates the application (S401). Here, not only activation of an application, but also logs-in processing may be performed by inputting an ID and a password to a recipe providing site.

Next, the receiver 212 receives input that indicates ingredient information and cooking recipe specification information (S402).

Next, the communicator 211 transmits to the server system 100 the ingredient information and the cooking recipe specification information received in step S402 (S403). At this point, the communicator 211 also transmits an ID associated with the application to the server system 100.

The communicator 211 then receives the third cooking recipe information transmitted from the server system 100 (S404), and the presenter 213 displays an image and a character string that indicate the third cooking recipe information (S405).

### Specific Examples

Next, a description is given using specific examples. First, specific example 1 will be described.

### Specific Example 1

Specific example 1 is an example in which ¼ of napa cabbage is left and a user tries to cook based on recipe A indicated by the first cooking recipe information 400 of FIG. 3. Here, since napa cabbage is not included in the use ingredient information 410 of the first cooking recipe information 400, even if a user cooks based on recipe A, ¼ of napa cabbage is not used up but is left.

First, a user activates an application using the information terminal 210 (S401), and performs input for specifying the first cooking recipe information as cooking recipe specification information and input for specifying ¼ napa cabbage as ingredient information. Thus, the input received by the receiver 212 of the information terminal 210.

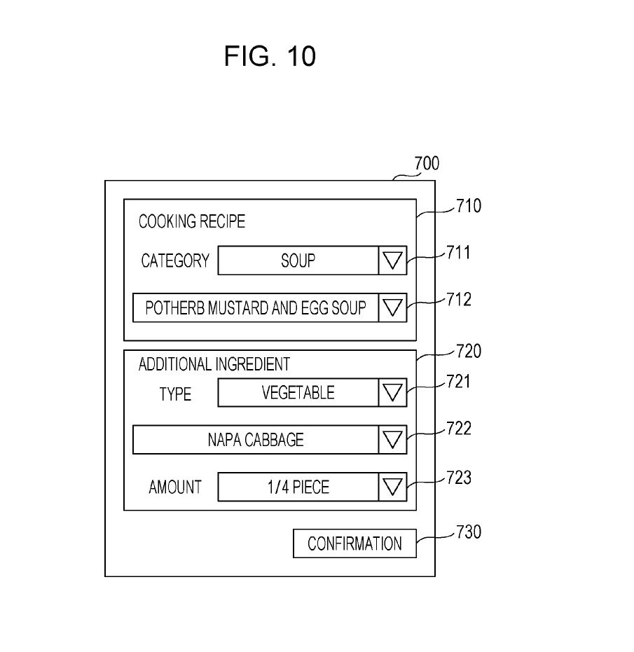

FIG. 10 is a chart illustrating an example of UI (User Interface) 700 for input in an application of the information terminal 210.

As illustrated in FIG. 10, in the UI 700, cooking recipe field 710 for inputting cooking recipe specification information, additional ingredient field 720 for inputting ingredient information, and confirmation button 730 are displayed.

In the cooking recipe field 710, category field 711 for inputting a category of cooking recipe, and cooking recipe selection field 712 for selecting a desired cooking recipe from a plurality of cooking recipes applicable to the category inputted to the category field 711 are displayed. When a user wants to select “soup of potherb mustard and egg” as the first cooking recipe information, “soup” is selected in the category field 711, thereby making it possible to narrow down cooking recipes selectable from the cooking recipes in the cooking recipe selection field 712 to the cooking recipes applicable to the category of “soup”. The user then is able to select a desired cooking recipe by performing input to select “soup of potherb mustard and egg” in the cooking recipe selection field 712 from the cooking recipes applicable to the category of “soup”.

In the additional ingredient field 720, type field 721 for inputting the type of additional ingredient, ingredient selection field 722 for selecting a desired ingredient from a plurality of ingredients applicable to the type inputted to the type field 721, and amount input field 723 for inputting an amount of the additional ingredient selected in the ingredient selection field 722 are displayed. When a user wants to input “¼ of napa cabbage” as the additional ingredient, “vegetable” is selected in the type field 721, thereby making it possible to narrow down selectable ingredients in the ingredient selection field 722 to the ingredients applicable to the type of “vegetable”. The user then is able to select desired additional ingredient by performing input to select “napa cabbage” in the ingredient selection field 722 from the ingredients applicable to the type of “vegetable”. When ingredient is selected in the ingredient selection field 722, it is possible to select an amount of ingredient in the unit corresponding to the selected ingredient in the amount input field 723. In this case, since “napa cabbage” is selected in the ingredient selection field 722, it is possible to select an amount of the ingredient in the unit “piece” corresponding to “napa cabbage”. In the amount input field 723, for instance, ⅛ piece, ¼ piece, ½ piece, and ¾ piece may be selected.

It is to be noted that in each the fields 711, 712, 721 to 723 of the UI 700, each item is selectable by pull-down. However, input is not limited to selection by pull-down, and a field for inputting a text may be provided and input indicating cooking recipe specification information and ingredient information may be received by identifying a cooking recipe and an ingredient from an inputted text.

Although ingredient is narrowed down by inputting a major classification of ingredient type illustrated in FIG. 5 in the category field 711, the type field 721, without being limited to this, a major classification and an intermediate classification may be inputted to narrow down the ingredient.

In this manner, when input to the cooking recipe field 710 and the additional ingredient field 720 is received by the receiver 212 of the information terminal 210, then input to the confirmation button 730 is received, the communicator 211 of the information terminal 210 transmits the inputted cooking recipe specification information and ingredient information to the server system 100 (S403).

Next, the server system 100 receives cooking recipe specification information in which the first cooking recipe information 400 is specified, and ingredient information in which ¼ of napa cabbage is specified (S101). The extractor 111 of the server system 100 then extracts second cooking recipe information 800 similar to the first cooking recipe information 400 (S102).

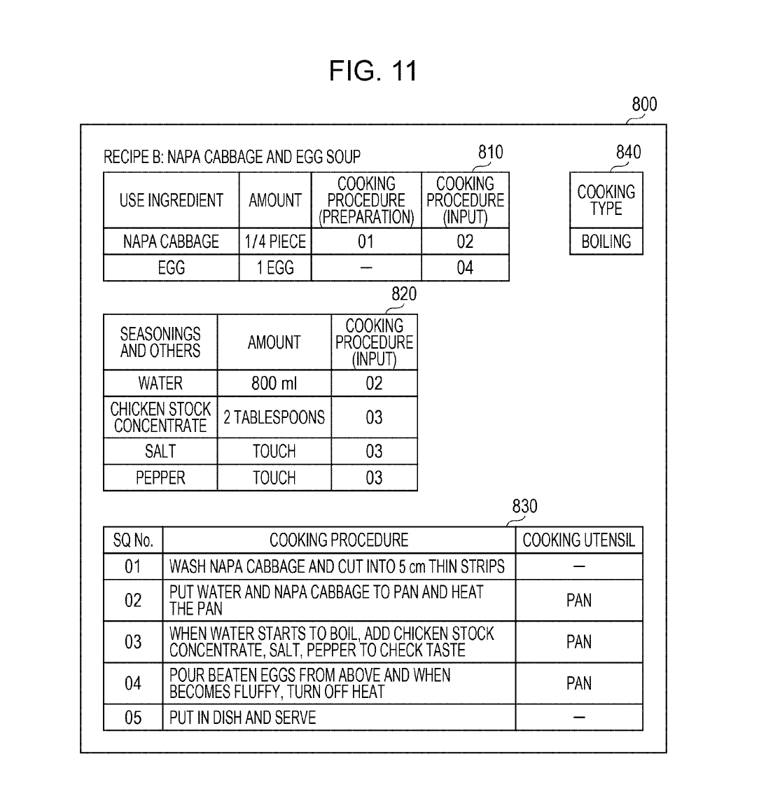

FIG. 11 is a chart illustrating another example of the pieces of cooking recipe information stored in the database 120. FIG. 11 illustrates the second cooking recipe information 800 similar to the first cooking recipe information 400. Similarly to the first cooking recipe information 400, the second cooking recipe information 800 also includes use ingredient information 810, seasoning information 820, cooking procedure information 830, and cooking type information 840. Each information is the same as in the first cooking recipe information 400, and thus a detailed description is omitted.

Next, the generator 112 determines whether or not “napa cabbage” indicated by the received ingredient information is included in the use ingredient information 810 of the second cooking recipe information 800 (S103). Since “napa cabbage” is included in the use ingredient information 810 (Yes in S103), the third cooking recipe information is generated by adding information regarding “napa cabbage” of the second cooking recipe information 800 to the first cooking recipe information 400 (S104).

Specifically, the generator 112 determines the amount of “napa cabbage” to be added to the first cooking recipe information 400 to be ¼ piece which is the amount corresponding to “napa cabbage” in the use ingredient information 810 of the second cooking recipe information 800 (S301). In this case, the amount, ¼ piece of “napa cabbage” received as the ingredient information is compared with the determined amount ¼ piece, and it is determined whether or not the determined amount is greater than or equal to the received amount. As a result of the determination, when it is determined that the determined amount is greater than or equal to the received amount, the received amount is determined to be the amount of the additional ingredient. That is, since the amount of “napa cabbage” of the use ingredient information 810 and the amount of received “napa cabbage” are the same “¼ piece”, “¼ piece” is determined to be the amount of the additional ingredient.

On the other hand, when it is determined that the determined amount is less than the received amount, the flow may return to the processing in step S102 to extract another similar cooking recipe information from the pieces of cooking recipe information stored in the database 120, or a user may be asked whether or not another cooking is further made via the information terminal 210. In the former case, processing is repeated until cooking recipe information satisfying the affirmative determination as to amount is extracted. In the latter case, for cooking newly added by a user, the same processing as in step S101 is repeated with the remaining amount (in short, the amount obtained by subtracting the determined amount of the additional ingredient from the received amount of the additional ingredient) of the additional ingredient (napa cabbage). In either of the former case and the latter case, when a suitable cooking recipe may not be determined, a command may be issued to the information terminal 210 such that a notification of this fact is displayed.

Next, a cooking procedure for preparation of “napa cabbage” is determined from the cooking procedure for preparation of “napa cabbage” of the second cooking recipe information 800 (S302). Specifically, “napa cabbage is washed and cut into 5 cm thin pieces” of the “cooking procedure” field of the cooking procedure information 830 is a cooking procedure, which corresponds to “01” of the “cooking procedure (preparation)” field associated in the use ingredient information 810, and is determined as the cooking procedure for preparation of the additional ingredient. It is to be noted that it is determined that the cooking procedure for preparation of the additional ingredient is inserted before or after a cooking procedure for preparation of other ingredients of the cooking procedure information 430 of the first cooking recipe information 400. Specifically, the cooking procedure for preparation of the additional ingredient is inserted before or after a cooking procedure corresponding to “01” or “02” of the “cooking procedure (preparation)” field indicated by the use ingredient information 410 of the first cooking recipe information 400. Here, it is determined that the cooking procedure for preparation of the additional ingredient is inserted after a cooking procedure for preparation of “potherb mustard” which is the same ingredient type as the additional ingredient out of other ingredients, for instance.

Next, the sequence number for inputting “napa cabbage” in a cooking utensil is determined based on a cooking utensil corresponding to a cooking procedure for input of “napa cabbage” in a cooking utensil of the second cooking recipe information 800, “boiling” of the cooking type information 840, the standard input information 500, and the ingredient type information 600 (S303). Specifically, it is seen from the ingredient type information 600 that the intermediate classification of ingredient type of napa cabbage as the additional ingredient is “white leafy vegetable”, and from the standard input information 500 that when the cooking type is “boiling”, “white leafy vegetable” is inputted to a pan before “blue leafy vegetable” is inputted when the state of the water in the pan is “unboiled water”. Thus, it is identified that the timing for inputting “napa cabbage” to a pan is set after “put water in a pan and boil” with the sequence number “03” and before “when the water starts to boil, input chicken stock concentrate” with the sequence number “04” in the cooking procedure information 430 of the first cooking recipe information 400. In other words, an additional cooking procedure for input of additional ingredient, that is, “input napa cabbage to a pan” is generated and additionally inserted between the sequence number “03” and the sequence number “04” which are determined based on the standard input information of the cooking procedure information 430 of the first cooking recipe information 400.

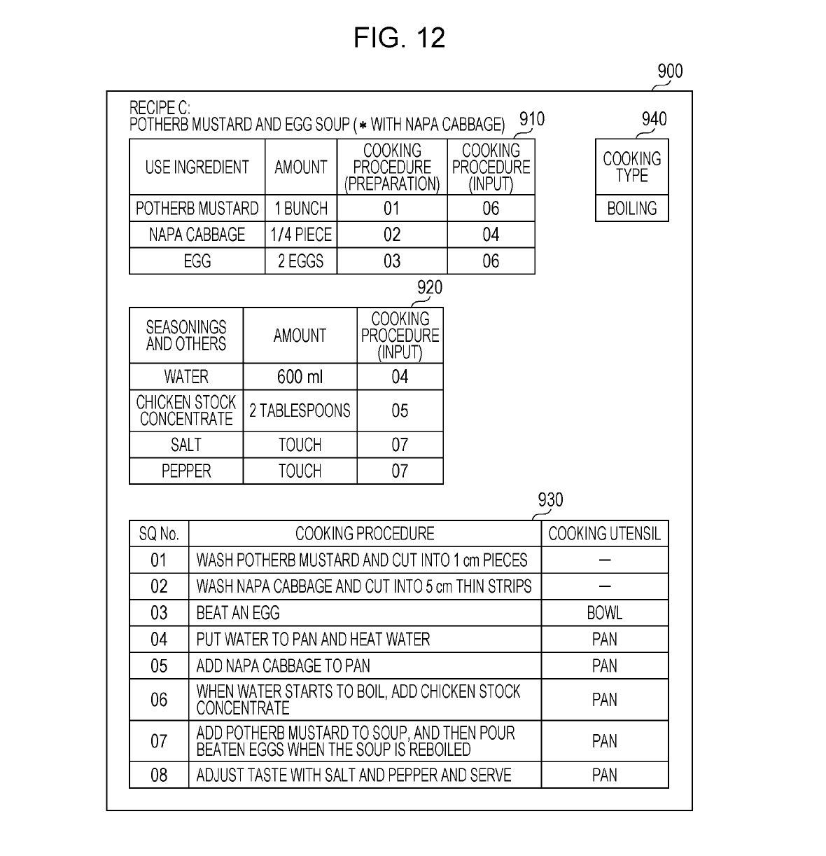

Finally, the generator 112 generates the third cooking recipe information as illustrated in FIG. 12 by adding the amount of the additional ingredient determined in step S301, a cooking procedure for preparation of the additional ingredient determined in step S302, and a sequence number for inputting the additional ingredient to a cooking utensil determined in step S303 to the first cooking recipe information 400 (S304). FIG. 12 is a chart illustrating an example of third cooking recipe information 900 generated by the generator 112 of the server system 100. Similarly to the first cooking recipe information 400, the third cooking recipe information 900 also includes use ingredient information 910, seasoning information 920, cooking procedure information 930, and cooking type information 940. Each information is the same as in the first cooking recipe information 400, and thus a detailed description is omitted.

The communicator 113 then transmits the third cooking recipe information 900 generated by the generator 112 to the information terminal 210 which has transmitted the cooking recipe specification information and the ingredient information (S105).

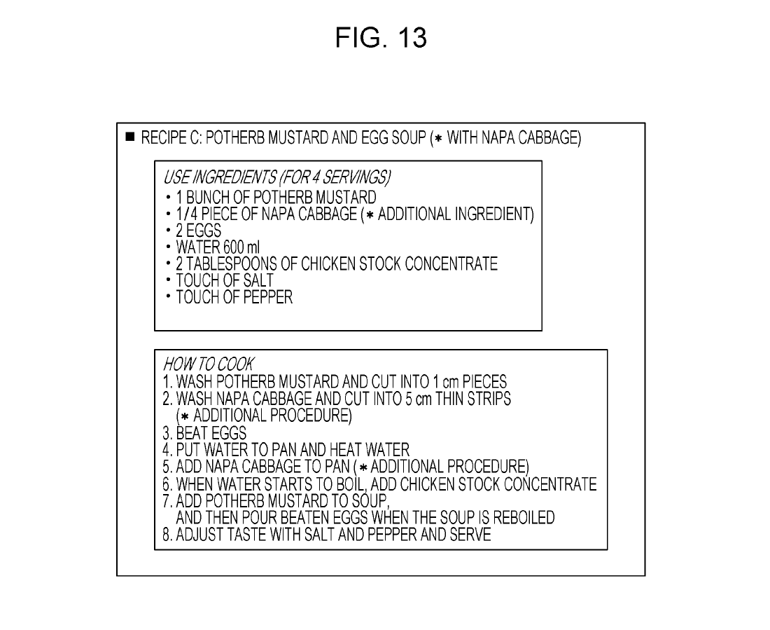

The information terminal 210 receives the third cooking recipe information 900 (S404), and in the presenter 213, displays, for instance, an image and/or a character string illustrating recipe C indicated by the third cooking recipe information 900 as illustrated in FIG. 13 (S405). It is to be noted that FIG. 13 is an example of display of recipe C indicated by the third cooking recipe information.

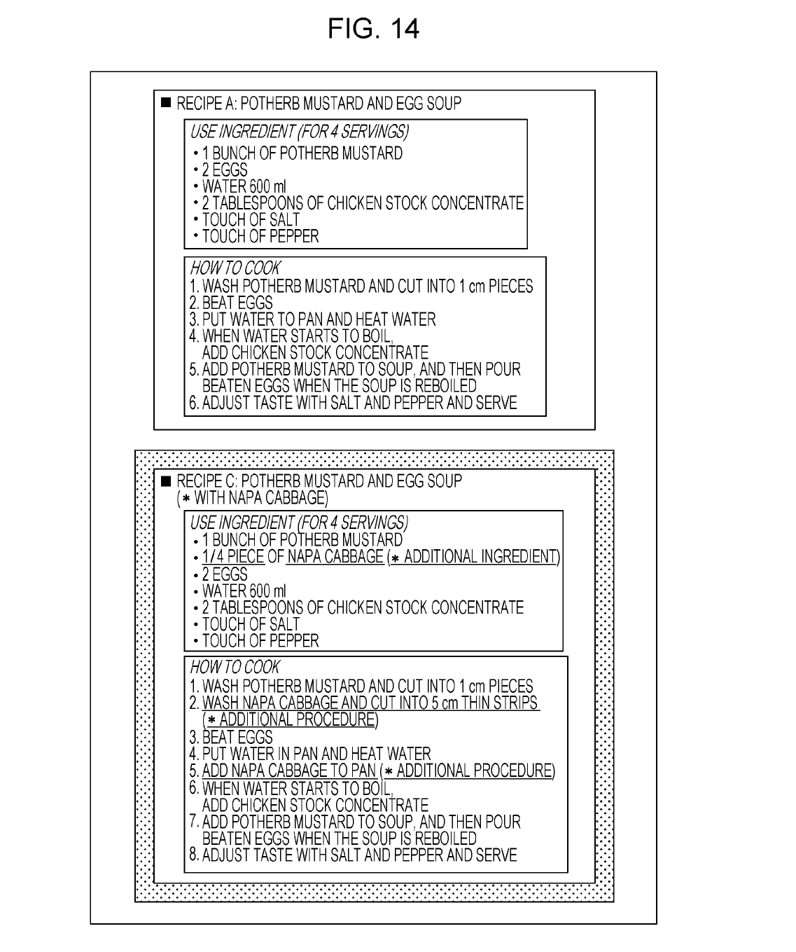

In step S105, recipe A indicated by the first cooking recipe information 400 along with recipe C indicated by the third cooking recipe information 900 may be placed side by side, and display information for displaying recipe A and recipe C in a comparison format may be transmitted to the information terminal 210. In this case, based on the display information, for instance, recipe A and recipe C as illustrated in FIG. 14 are placed side by side and displayed on the same screen in the presenter 213 of the information terminal 210. The display information may be transmitted as a control command to the information terminal 210, or the information terminal 210 may determine whether or not display is needed based on the display information. The detail of the display information transmitted from the server system 100 to the information terminal 210 has been described, and in this process, the information terminal 210 may generate display information for displaying recipe A and recipe C in a comparison format based on the first cooking recipe information and the third cooking recipe information. It is to be noted that FIG. 14 is an example of display of recipe A and recipe C in a comparison format.

### Specific Example 2

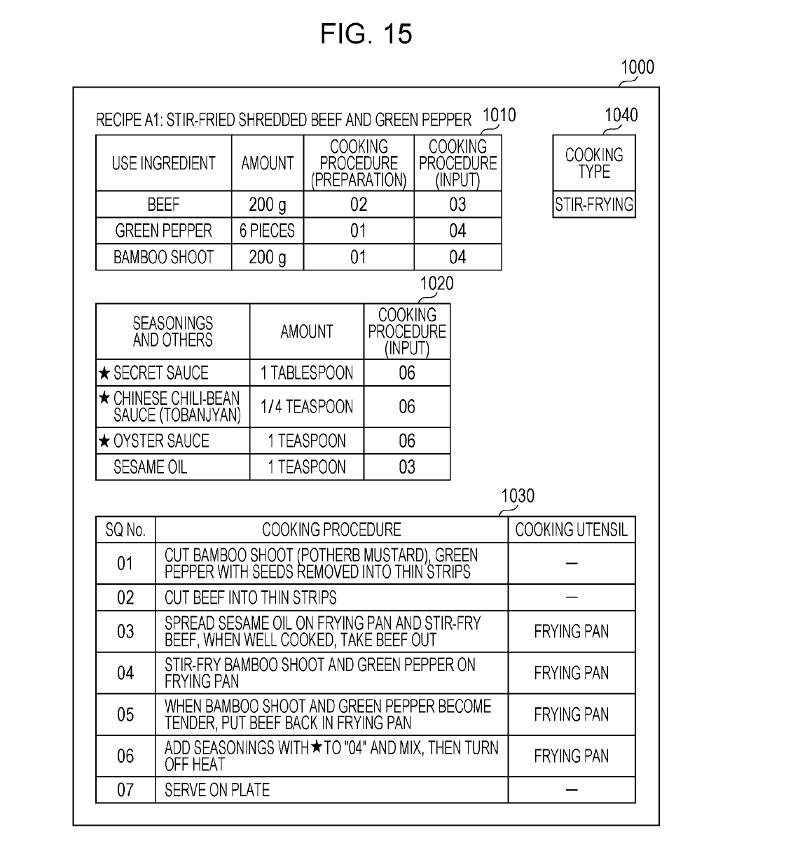

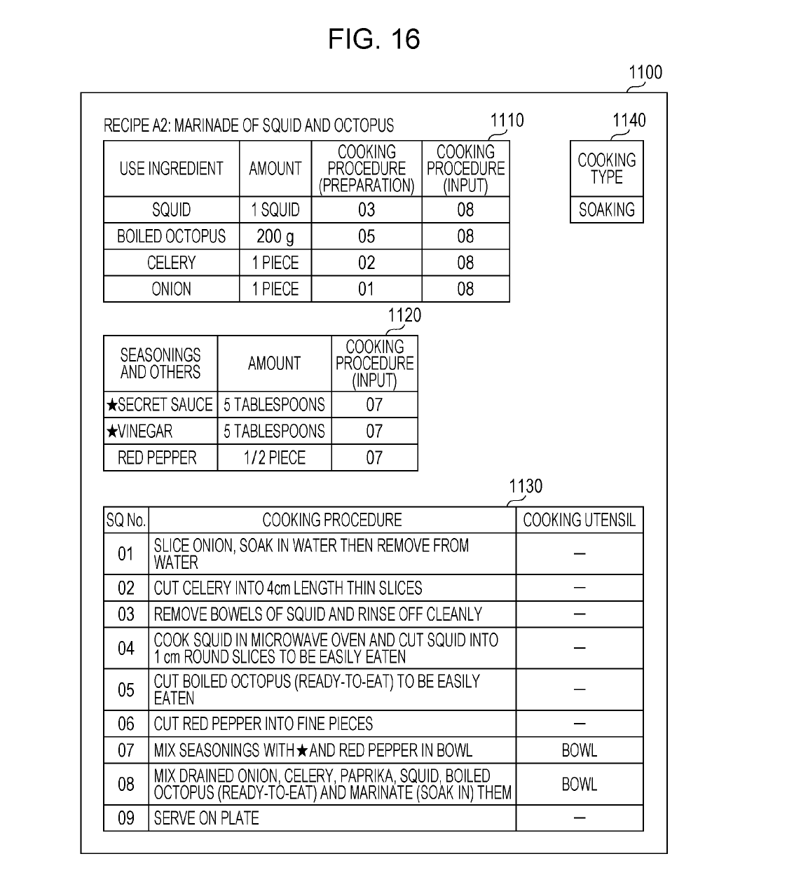

Specific example 2 is an example in which one paprika is left and a user tries to cook a dish of a menu including a plurality of types of cooking (cooking according to recipe A1 and cooking according to recipe A2). FIG. 15 is a chart illustrating cooking recipe information 1000 indicating recipe A1. FIG. 16 is a chart illustrating cooking recipe information 1100 indicating recipe A2. Similarly to the first cooking recipe information 400, the cooking recipe information 1000, 1100 include use ingredient information 1010, 1110, seasoning information 1020, 1120, cooking procedure information 1030, 1130, and cooking type information 1040, 1140, respectively. Each information is the same as in the first cooking recipe information 400, and thus a detailed description is omitted.

In this case, the cooking recipe information 1000 specifying recipe A1 and the cooking recipe information 1100 specifying recipe A2 provide the use ingredient information 1010, 1110 which do not include a paprika. Thus, even when a user cooks the dished in the menu as it is, the paprika is not used up but is left.

Similarly to the specific example 1, a user first inputs cooking recipe specification information and ingredient information using the information terminal 210. Although details are omitted, in this case, two cooking recipes may be inputted as the cooking recipe specification information. The information terminal 210 then transmits the cooking recipe specification information indicating the two inputted cooking recipes and the ingredient information to the server system 100.

Next, in the server system 100, the cooking recipe specification information specifying recipe A1 and recipe A2, and the ingredient information specifying a paprika are received (S101). The extractor 111 of the server system 100 then extracts cooking recipe information similar to the cooking recipe information 1000 specifying recipe A1, and cooking recipe information similar to the cooking recipe information 1100 specifying recipe A2 from the pieces of cooking recipe information stored in the database 120 (S102). That is, in step S102, when received cooking recipe specification information specifies pieces of the first cooking recipe information, for each of the pieces of the first cooking recipe information, second cooking recipe information similar to the first cooking recipe information is extracted from the pieces of cooking recipe information stored in the database 120.

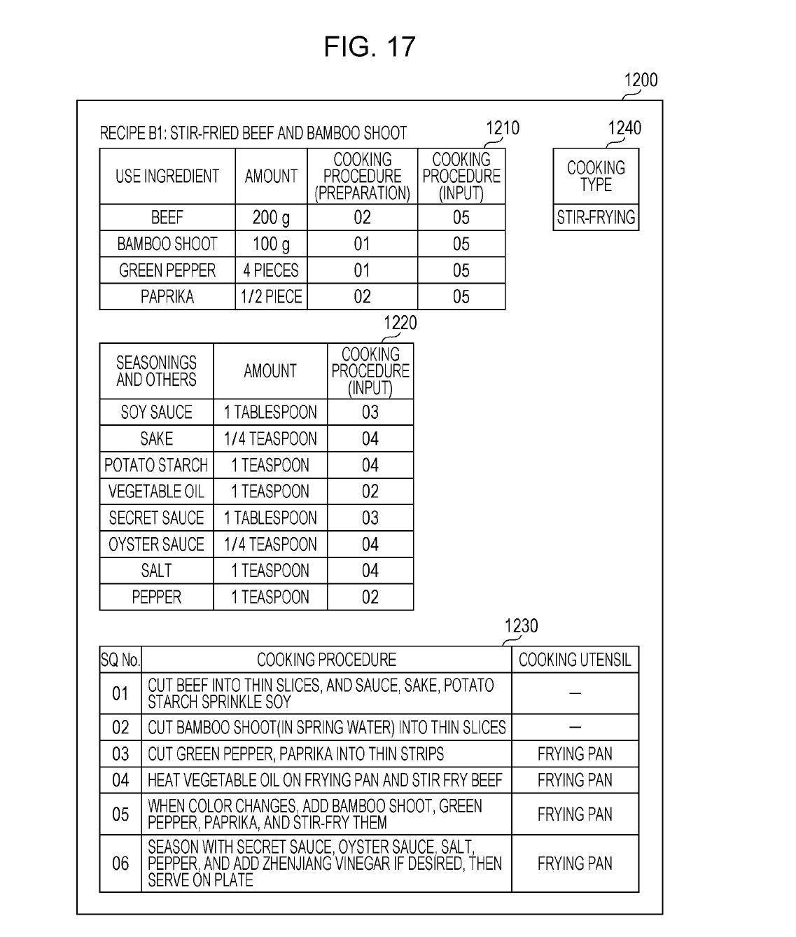

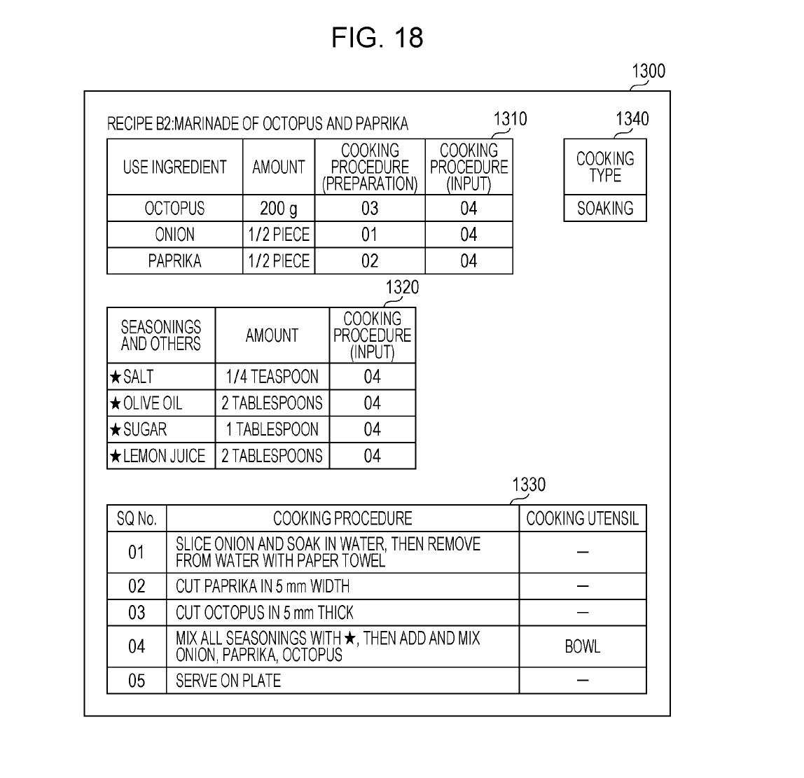

FIG. 17 is a chart illustrating cooking recipe information 1200 similar to the cooking recipe information 1000 of recipe A1. FIG. 18 is a chart illustrating cooking recipe information 1300 similar to the cooking recipe information 1100 of recipe A2. Similarly to the first cooking recipe information 400, the cooking recipe information 1200, 1300 include use ingredient information 1210, 1310, seasoning information 1220, 1320, cooking procedure information 1230, 1330, and cooking type information 1240, 1340, respectively. Each information is the same as in the first cooking recipe information 400, and thus a detailed description is omitted.

Next, the generator 112 determines whether or not the use ingredient information 1210, 1310 of the cooking recipe information 1200, 1300 include “paprika” indicated by the received ingredient information (S103). Since the use ingredient information 1210, 1310 include “paprika” (Yes in S103), the generator 112 generates third cooking recipe information by adding information regarding “paprika” of the cooking recipe information 1200, 1300 as the second cooking recipe information to the cooking recipe information 1000, 1100 as the first cooking recipe information (S104). That is, in step S104, when the ingredient indicated by the ingredient information is included in the use ingredient information of each of the extracted pieces of the second cooking recipe information corresponding to the pieces of the first cooking recipe information, the third cooking recipe information, in which the ingredient indicated by the ingredient information is added to the use ingredient information of the first cooking recipe information as the additional ingredient, is generated.

Specifically, in the generator 112, the amount of “paprika” added to the cooking recipe information 1000, 1100 is determined to be the sum of ½ piece which is the amount corresponding to “paprika” of the use ingredient information 1210, 1310 of the cooking recipe information 1200, 1300 (S301). In this case, the amount, 1 piece of “paprika” received as the ingredient information is compared with the sum of the determined amounts (that is, ½ piece+½ piece), and it is determined whether or not the determined amount is greater than or equal to the received amount. As a result of the determination, when it is determined that the determined amount is greater than or equal to the received amount, the received amount is determined to be the amount of the additional ingredient. That is, since the sum of the amounts of “paprika” of the use ingredient information 1210, 1310 and the amount of received “napa cabbage” are the same “1 piece”, “½ piece” is determined to be the amount of the additional ingredient for each.

On the other hand, when it is determined that the determined amount is less than the received amount, the same goes with the case described in specific example 1. It is to be noted that since a plurality pieces of target cooking recipe information is present, it is sufficient that the same processing as in specific example 1 be performed for at least one piece of cooking recipe information.

Next, a cooking procedure for preparation of “paprika” is determined from the cooking procedure for preparation of “paprika” in each of the cooking recipe information 1200, 1300 as the second cooking recipe information (S302). The processing of determination of a cooking procedure in this case may be performed in the same manner as in specific example 1, and thus a detailed description is omitted.

Subsequently, a sequence number for inputting “paprika” to a cooking utensil is determined based on the cooking utensil corresponding to the cooking procedure for input of “paprika” in a cooking utensil in each of the cooking recipe information 1200, 1300 as the second cooking recipe information, “stir-frying” and “soaking” in each of the cooking type information 1240, 1340, and the ingredient type information (S303).

Specifically, it is seen from the ingredient type information (not illustrated) that the ingredient type of paprika as the additional ingredient is the same as the ingredient type of “green pepper”. Consequently, it is identified that when “paprika” is added to the cooking recipe information 1000, the timing of inputting “paprika” to a cooking utensil is the same as the timing of inputting “green pepper” to a cooking utensil. In other words, it is determined here that “paprika” is to be inputted in the cooking procedure for the sequence number “04” in the cooking procedure information 1030, which is the procedure for inputting “green pepper” in the cooking recipe information 1000. It is to be noted that it may be determined that “paprika” is to be inputted before or after the sequence number “04”.

Similarly, it is seen from the ingredient type information (not illustrated) that the ingredient type of paprika as the additional ingredient is the same as the ingredient type of “celery” and “onion”. Consequently, it is identified that when “paprika” is added to the cooking recipe information 1100, the timing of inputting “paprika” to a cooking utensil is the same as the timing of inputting “celery” and “onion” to a bowl. In other words, it is determined here that “paprika” is to be inputted in the cooking procedure for the sequence number “08” in the cooking procedure information 1130, which is the procedure for inputting “celery” and “onion” in the cooking recipe information 1100.

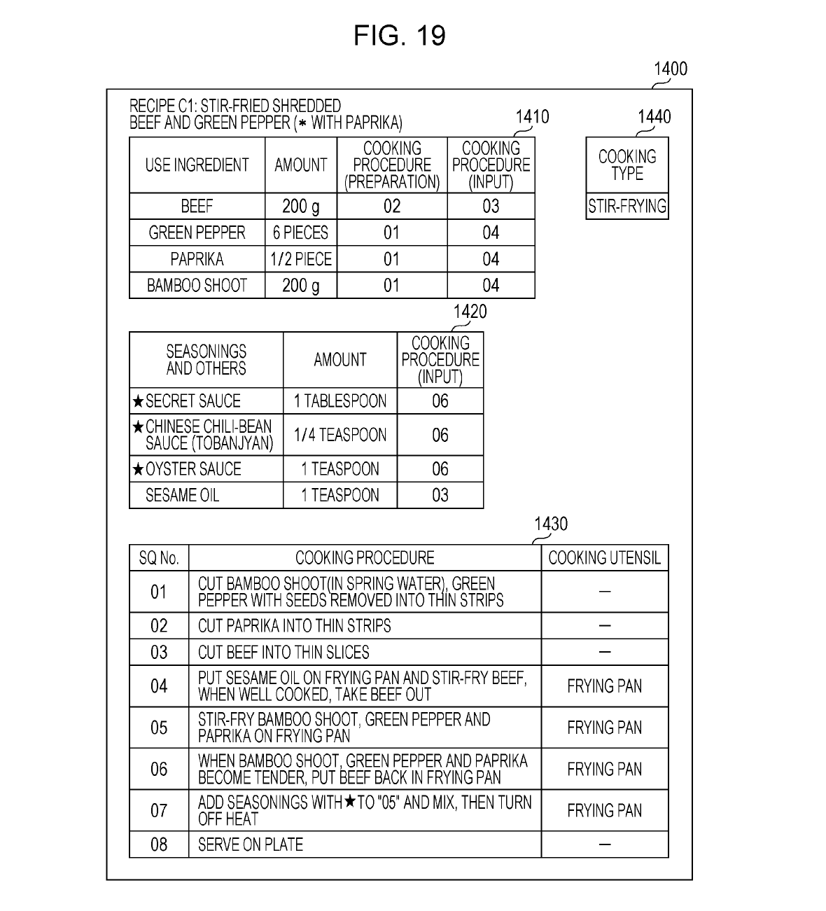

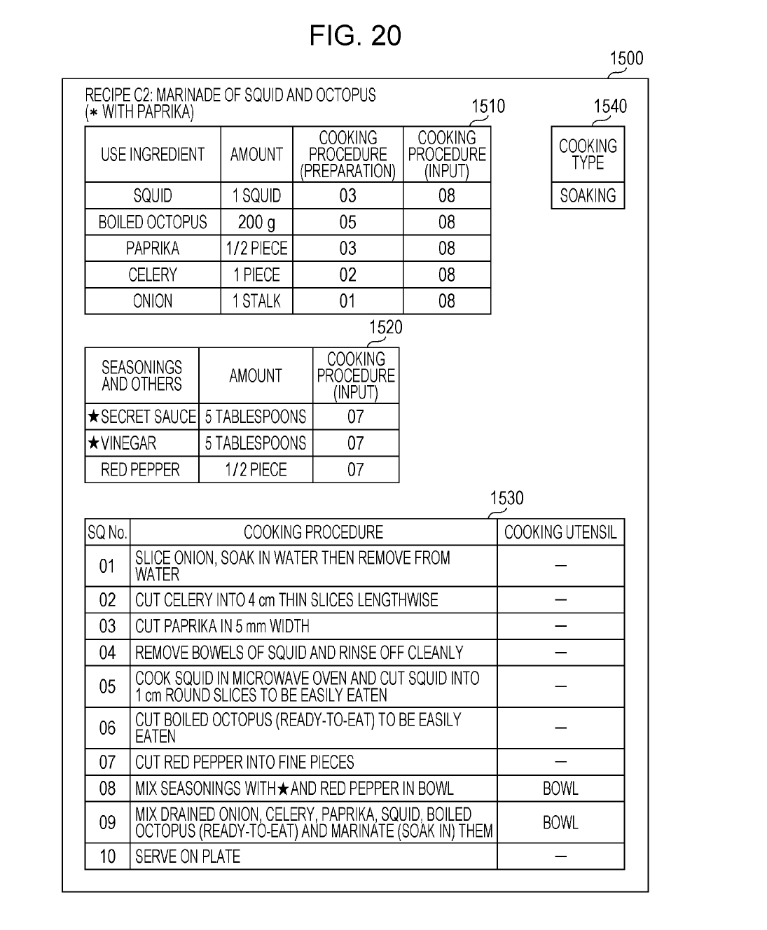

Finally, the generator 112 generates cooking recipe information 1400, 1500 as the third cooking recipe information as illustrated in FIG. 19 and FIG. 20 by adding the amount of the additional ingredient determined in step S301, a cooking procedure for preparation of the additional ingredient determined in step S302, and a sequence number for inputting the additional ingredient into a cooking utensil determined in step S303 to corresponding cooking recipe information 1000, 1100 (S304). It is to be noted that FIG. 19 and FIG. 20 are charts illustrating the cooking recipe information 1400, 1500 as the third cooking recipe information generated by the generator 112 of the server system 100. Similarly to the first cooking recipe information 400, the cooking recipe information 1400, 1500 also include use ingredient information 1410, 1510, seasoning information 1420, 1520, cooking procedure information 1430, 1530, and cooking type information 1440, 1540, respectively. Each information is the same as in the first cooking recipe information 400, and thus a detailed description is omitted.

The communicator 113 then transmits the cooking recipe information 1400, 1500 generated by the generator 112 to the information terminal 210 which has transmitted the cooking recipe specification information and the ingredient information (S105).

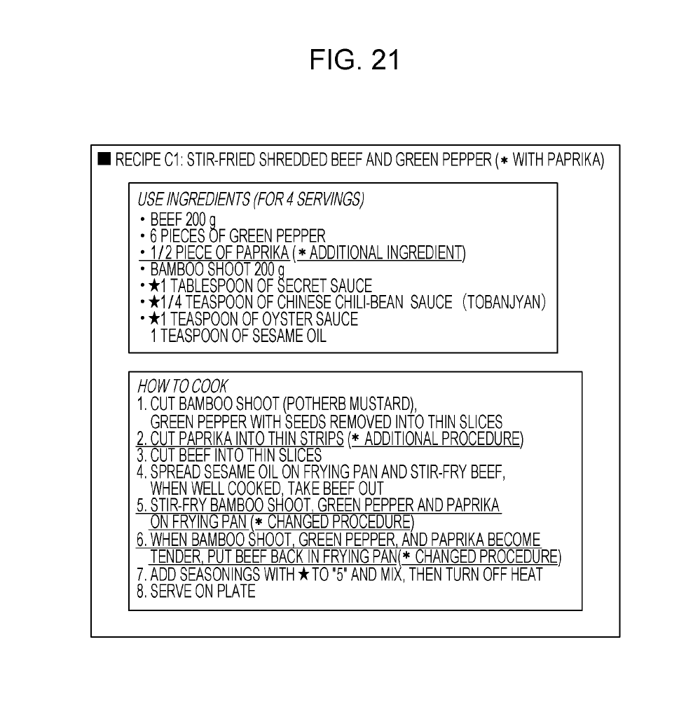

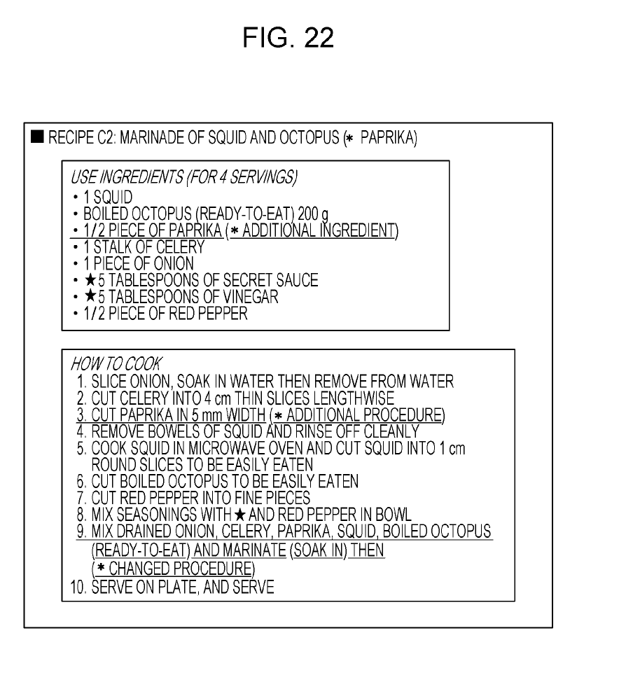

The information terminal 210 receives the cooking recipe information 1400, 1500 (S404), and in the presenter 213, for instance as illustrated in FIG. 21 and FIG. 22, displays an image and/or a character string illustrating recipe C1 and recipe C2 indicated by the cooking recipe information 1400, 1500 (S405). FIG. 21 is a display example of recipe C1 indicated by cooking recipe information. FIG. 22 is a display example of recipe C2 indicated by cooking recipe information.

### (Effects)

As described above, according to the present embodiment, only by specifying an ingredient and a cooking recipe, a user is able to obtain a cooking recipe which includes the specified ingredient and in which the specified ingredient is added to the specified cooking recipe based on a cooking recipe similar to the specified cooking recipe. Thus, for instance, when a user specifies an unused ingredient and an desired dish, a cooking recipe may be easily obtained, in which the unused ingredient is added to an ingredient menu indicated by a cooking recipe for the specified dish. Therefore, it is possible to use up the ingredient and to reduce consumption of unnecessary power.

In addition, according to the present embodiment, the second cooking recipe information is extracted from a plurality of pieces of cooking recipe information based on a degree of similarity determined using at least one of the type of ingredient, the type of seasoning, and the type of cooking, thereby making it possible to appropriately extract the second cooking recipe information similar to the first cooking recipe information.

Furthermore, according to the present embodiment, the amount of the additional ingredient in the use ingredient information of the third cooking recipe information is determined to be the amount of the ingredient indicated by the use ingredient information of the second cooking recipe information, thereby making it possible to appropriately determine the amount of the additional ingredient.

Furthermore, according to the present embodiment, a cooking procedure for an additional ingredient is added as the third cooking recipe information. Specifically, it is possible to generate a cooking recipe information as the third cooking recipe information in which the cooking procedure for an additional ingredient included in the cooking procedure information of the second cooking recipe information is added, and thus a user is able to cook, for instance, unused ingredient more appropriately.

According to the present embodiment, as the third cooking recipe information, a sequence number for an additional cooking procedure as a cooking procedure for input of the additional ingredient to a cooking utensil is determined to the sequence number either before or after a cooking procedure for input of an ingredient of the same ingredient type as the additional ingredient to the cooking utensil, thereby making it possible to appropriately determine a sequence number for cooking of the additional ingredient.

According to the present embodiment, cooking recipe information is generated as the third cooking recipe information by adding the generated additional cooking procedure to the cooking procedure information of the first cooking recipe information based on the standard input information, thereby making it possible to determine an appropriate sequence number for cooking of the additional ingredient.

According to the present embodiment, the information terminal 210 is able to display the use ingredient information of the first cooking recipe information and the use ingredient information of the third cooking recipe information in a comparison format, which allows a user to efficiently determine whether or not the displayed third cooking recipe information is to be adopted.

### (First Modification)

According to the above-described embodiments, the amount of the additional ingredient is determined to be the amount indicated by the second cooking recipe information similar to the specified first cooking recipe information.

However, without being limited to this, for instance, for each ingredient indicated by the use ingredient information included in each of a plurality of pieces of cooking recipe information, the cooking recipe information may further include additional amount information that indicates an amount of the ingredient allowed to be added. In other words, the cooking recipe information may include the amount (hereinafter, referred to as a “reference amount”) of each of one or more ingredients to be used for cooking, and an additional amount up to which the ingredient may be added in addition to the amount. In this case, in cooking, for each of one or more ingredients, the amount of the ingredient may be determined to be in a range of amount from the reference amount of the ingredient to the reference amount plus the additional amount. In other words, for each of the one or more ingredients to be used for cooking, the cooking recipe information may include information that indicates a range of amount in which the ingredient may be used.

In this case, the generator 112 may determine, in its generation, the amount of the additional ingredient in the use ingredient information of the third cooking recipe information in a range of the amount indicated by the additional amount information. The generator 112 may generate cooking recipe information including information indicating the amount of the additional ingredient obtained in the determining, as the third cooking recipe information.

According to this, the amount of the additional ingredient in the use ingredient information of the third cooking recipe information is determined in a range of the amount indicated by the additional amount information, thereby making it possible to appropriately determine the amount of the additional ingredient.

### (Second Modification)

According to the above-described embodiments, the third cooking recipe information is generated by further adding additional ingredient to the ingredient indicated by the use ingredient information included in the first cooking recipe information. However, without being limited to this, for instance, the generator 112 may select, in its generation, at least one ingredient indicated by the use ingredient information of the first cooking recipe information, and may generate cooking recipe information obtained by adding the additional ingredient instead of the selected ingredient, as the third cooking recipe information. In specific example 1, napa cabbage is further added to the use ingredient information 410 of the first cooking recipe information 400. However, the third cooking recipe information may be generated by adding napa cabbage instead of potherb mustard, for instance. In this case, a cooking procedure for napa cabbage instead of a cooking procedure for potherb mustard is added to a cooking procedure for preparation. In this manner, the additional ingredient is added as an alternative ingredient, and thus the additional ingredient may be used for cooking without increasing the amount of finished dishes.

### (Third Modification)

According to the above-described embodiments, an example has been described, in which the cooking type information of the first cooking recipe information matches the cooking type information of the second cooking recipe information, when both cooking type information are different, the third cooking recipe information may be generated as follows.

For instance, the generator 112 determines, in its generation, whether or not the cooking type information of the first cooking recipe information matches the cooking type information of the extracted second cooking recipe information. When the generator determines that the cooking type information of the first cooking recipe information is different from the cooking type information of the second cooking recipe information in the determination, the database 120 is referred, and cooking recipe information may be generated as the third cooking recipe information, in which a cooking procedure for preparation of the additional ingredient corresponding to the cooking type information of the first cooking recipe information is added to the cooking procedure information of the first cooking recipe information. In this case, the database 120 stores preparation information including a predetermined cooking procedure for preparation for each ingredient and each cooking type. According to this, even when the cooking type information of the first cooking recipe information is different from the cooking type information of the second cooking recipe information, cooking recipe information is generated as the third cooking recipe information, in which a cooking procedure appropriate to the additional ingredient and the cooking type of an addition destination cooking recipe is added, and thus a user is able to cook, for instance, an unused ingredient appropriately.

### (Fourth Modification)

According to the above-described embodiments, the extractor 111 determines a degree of similarity between the first cooking recipe information and each of the pieces of cooking recipe information stored in the database 120 by using at least one of an ingredient type, a seasoning type, and a cooking type included in the first cooking recipe information. However, without being limited to this, for instance, the extractor 111 may determine a degree of similarity between the first cooking recipe information and each of the pieces of cooking recipe information using the taste information value. Here, the taste information value is a value that is further included in each of the pieces of cooking recipe information stored in the database 120, and that represents at least one of sweetness, sourness, saltiness, bitterness, umami and pungent taste in terms of numerals. The taste information values included in the pieces of cooking recipe information may be compared with each other, and a rate (frequency) of matching between the taste information values in the tastes may be determined as a degree of similarity. For instance, when the numerical difference between taste information values in the tastes is in a range less than ±1, 3 points are accumulated, when the numerical difference is in a range of ±1 or more and less than ±2, 2 points are accumulated, and when the numerical difference is in a range of ±2 or more and less than ±3, 1 point is accumulated, and thereby a degree of similarity may be determined in terms of the accumulated points.

According to this, the second cooking recipe information is extracted from the plurality of pieces of cooking recipe information based on a degree of similarity determined using the taste information value, thereby making it possible to appropriately extract the second cooking recipe information similar to the first cooking recipe information.

### (Fifth Modification)

In the above-described embodiments, each component may be formed by dedicated hardware, or may be implemented by executing a software program suitable for the component. Each component may be implemented by a program executor such as a CPU or a processor, that reads and executes a software program recorded on a storage medium such as a hard disk or semiconductor memory. Here, software which implements the cooking recipe providing method in the above-described embodiments is the program as follows.

That is, the program causes a computer to perform a method of providing cooking recipes in a cooking recipe providing system that is connected to an information terminal via a network and that provides cooking recipes. The cooking recipe providing system includes a database that stores a plurality of pieces of cooking recipe information, each of which has use ingredient information which indicates ingredients to be used for cooking, and the cooking recipe providing method includes: receiving from the information terminal, ingredient information indicating a type and an amount of an ingredient, and cooking recipe specification information specifying a first cooking recipe information in which the use ingredient information does not include the ingredient indicated by the ingredient information; extracting a second cooking recipe information similar to the first cooking recipe information indicated by the received cooking recipe specification information from the pieces of cooking recipe information stored in the database; and when the ingredient indicated by the ingredient information is included in the use ingredient information of the extracted second cooking recipe information, generating a third cooking recipe information in which the ingredient indicated by the ingredient information is added to the use ingredient information of the first cooking recipe information as an additional ingredient.

Although a cooking recipe providing method and a cooking recipe providing system according to one more aspects of the present disclosure have been described above based on embodiments, the present disclosure is not limited to those embodiments. As long as not departing from the spirit of the present disclosure, embodiments in which various modifications which will occur to those skilled in the art are made on the present embodiments and an embodiment constructed by a combination of components of different embodiments are also included within the scope of one more aspects of the present disclosure.

The present disclosure is useful as a cooking recipe providing method capable of providing a cooking recipe that allows unused ingredients to be used up.

What is claimed is:

1. A method comprising:
receiving, using a processor, from an information terminal via a network, ingredient information indicating a type and an amount of an ingredient, and recipe specification information specifying a first recipe which does not include the ingredient indicated by the ingredient information, wherein the first recipe includes first use ingredient information indicating each ingredient to be used for cooking, and the first use ingredient information does not include the ingredient indicated by the ingredient information;
extracting, using the processor, a second recipe similar to the first recipe indicated by the recipe specification information from a plurality of recipes stored in a database; and
when the ingredient indicated by the ingredient information is included in second use ingredient information of the second recipe, generating a third recipe in which the ingredient indicated by the ingredient information is added to the first use ingredient information of the first recipe as an additional ingredient, outputting the third recipe to the information terminal.

2. The method according to claim 1, wherein
one of the plurality of recipes includes at least one of a type of ingredient to be used for cooking, a type of seasoning to be used for the cooking, and a cooking type of the cooking, and
in the extracting,
a degree of similarity between the first recipe and each of the plurality of recipes is determined using at least one of the type of ingredient, the type of seasoning, and the cooking type included in the first recipe, and
the second recipe is extracted from the plurality of recipes based on the degree of similarity obtained in the determining.

3. The method according to claim 1, wherein
one of the plurality of recipes further includes a taste information value that represents at least one of sweetness, sourness, saltiness, bitterness, umami and pungent taste in terms of a numeral, and
in the extracting,
a degree of similarity between the first recipe and each of the plurality of recipes is determined using the taste information value, and
the second recipe is extracted from the plurality of recipes based on the degree of similarity obtained in the determining.

4. The method according to claim 1, wherein
the use ingredient information includes information that indicates an amount of each ingredient to be used for cooking, and
in the generating,
an amount of the additional ingredient in the use ingredient information of the third recipe is determined to be the amount of the ingredient indicated by the use ingredient information of the second recipe, and
a recipe including information indicating the amount of the additional ingredient obtained in the determining is generated as the third recipe.

5. The method according to claim 1, wherein
the use ingredient information includes information that indicates an amount of each ingredient to be used for cooking,
each of the plurality of recipes includes additional amount information for each of the ingredients indicated by the use ingredient information included in the recipe, the additional amount information indicating an amount of the ingredient allowed to be added, and
in the generating,
an amount of the additional ingredient in the use ingredient information of the third recipe is determined in a range of the amount indicated by the additional amount information, and
a recipe including information indicating the amount of the additional ingredient obtained in the determining is generated as the third recipe.

6. The method according to claim 1, wherein
in the generating,
at least one of the ingredients indicated by the use ingredient information of the first recipe is selected, and
a recipe obtained by adding the additional ingredient instead of the selected ingredient to the first recipe is generated as the third recipe.

7. The method according to claim 1, wherein
one of the plurality of recipes includes cooking procedure information that indicates a cooking procedure, and
in the generating, a recipe in which a cooking procedure for the additional ingredient is added as a cooking procedure indicated by the cooking procedure information of the first recipe is generated as the third recipe.

8. The method according to claim 7, wherein
in the generating, a cooking procedure for preparation of the additional ingredient included in cooking procedure information of the second recipe is added to the cooking procedure information of the first recipe, and a recipe obtained by the addition is generated as the third recipe.

9. The method according to claim 7, wherein
one of the plurality of recipes includes cooking type information that indicates a cooking type,
as the cooking procedure, the cooking procedure information indicates a cooking procedure for preparation of an ingredient corresponding to a type of the ingredient and a cooking type of dish,
the generating including:
determining whether or not the cooking type information of the first recipe matches the cooking type information of the extracted second recipe, and
when determining that the cooking type information of the first recipe is different from the cooking type information of the second recipe in the determining, referring to the database to generate, as the third recipe, a recipe in which a cooking procedure for preparation of the additional ingredient corresponding to the cooking type information of the first recipe is added to the cooking procedure information of the first recipe.

10. The method according to claim 7, wherein
the use ingredient information includes ingredient type information that indicates an ingredient type of each ingredient, and
the generating includes:
generating an additional cooking procedure which is a cooking procedure for input of the additional ingredient to a cooking utensil; and
generating, as the third recipe, cooking recipe information by adding the generated additional cooking procedure to the cooking procedure information of the first recipe either before or after a cooking procedure for input of an ingredient of the same ingredient type as the additional ingredient to the cooking utensil, out of the ingredients indicated by the use ingredient information of the first recipe.

11. The method according to claim 7, wherein
one of the plurality of recipes includes cooking type information that indicates a cooking type,
the use ingredient information further includes ingredient type information that indicates an ingredient type of each ingredient,
the database further stores standard input information that indicates an input sequence number of the ingredient to a cooking utensil corresponding to the ingredient type and the cooking type, and
the generating includes:
generating an additional cooking procedure which is a cooking procedure for input of the additional ingredient to a cooking utensil; and
generating, as the third recipe, a recipe obtained by adding the generated additional cooking procedure to the cooking procedure information of the first recipe based on the standard input information.

12. The method according to claim 1, wherein
in the extracting,
when the received cooking recipe specification information specifies a plurality of the first recipes, a second recipe similar to each of the plural first recipes is extracted from the recipes stored in the database, and
in the generating, when the ingredient indicated by the ingredient information is included in the use ingredient information of any of the extracted plural second recipes corresponding to the plural first recipes, the third recipe is generated, in which the ingredient indicated by the ingredient information is added to the use ingredient information of the first recipe as an additional ingredient.

13. The method according to claim 1, wherein the operations further comprises transmitting to the information terminal, display information for displaying the use ingredient information of the first recipe and the use ingredient information of the third recipe in a comparison format.

14. The method according to claim 1, wherein
the information terminal has a touch panel,
in the receiving, user inputting the ingredient information and the recipe specification information using the touch panel,
the information terminal displays the third recipe on the touch panel.

15. A non-transitory recording medium having a computer program stored thereon, the computer program causing a processor to execute operations comprising:
receiving from an information terminal via a network, ingredient information indicating a type and an amount of an ingredient, and recipe specification information specifying a first recipe which does not include the ingredient indicated by the ingredient information, wherein the first recipe includes first use ingredient information indicating each ingredient to be used for cooking, and the first use ingredient information does not include the ingredient indicated by the ingredient information;
extracting a second recipe similar to the first recipe indicated by the recipe specification information from a plurality of recipes stored in a database; and
when the ingredient indicated by the ingredient information is included in second use ingredient information of the second recipe, generating a third recipe in which the ingredient indicated by the ingredient information is added to the first use ingredient information of the first recipe as an additional ingredient, outputting the third recipe to the information terminal.
